(19) United States
(12) Patent Application Publication
(10) Pub. No.: US 2005/0216611 A1
(43) Pub. Date: Sep. 29, 2005

(54) Method and apparatus to achieve data pointer obfuscation for content protection of streaming media DMA engines

(76) Inventor: Alberto J. Martinez, El Dorado Hills, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/813,537

(22) Filed: Mar. 29, 2004

(51) Int. Cl. G06F 12/14

(52) U.S. Cl. 710/22; 711/163

(57) ABSTRACT

Embodiments include a system for obfuscating the location of protected data in the memory of a computer system. The system provides a protected mode supported by a memory controller that does not allow the address relating to the location of protected data to be read or accessed. This system may be used to prevent the piracy of data temporarily stored in an unencrypted state in system memory.

### BACKGROUND

1. Field of the Invention

The embodiments of the invention relate to memory resource management. Specifically, the embodiments of the invention relate to protecting the location of data in physical system memory.

2. Background

Computer systems utilize a variety of devices such as Host Controllers (HC) to move data between computer system memory and external physical input-output (I/O) ports such as video display systems and audio rendering digital analog converters (DAC). Software applications on the computer system access HCs via Host Controller Interface (HCI) registers. HCI registers provide command control and status information for Direct Memory Access (DMA) engines that are part of the HC. A central processing unit (CPU) in a computer system would be inefficient if it directly accessed data from an HC by accessing memory mapped I/O or traditional I/O registers in the HC. These access operations are prone to long latencies due to I/O interface speed protocols. Instead, segments of data provided by or to these devices are retrieved and stored in system memory, which has a significantly shorter access time for a CPU. Storing data in system memory improves the efficiency of the computer system by avoiding unnecessary delays caused by utilizing the I/O subsystem.

A direct memory access (DMA) controller engine in the HC receives read and write requests from a CPU and handles these requests without the need for the CPU to become involved in the transfer process. The DMA controller thereby further improves the efficient use of the CPU by handling memory transfer work and allowing the CPU to do other work at the same time. A DMA controller writes blocks of data from the HC device to system memory for read/output and write requests and from system memory to the HC device for write/input requests. When a transfer of data is complete the DMA controller notifies the CPU and provides the CPU with information about the location of the data in system memory.

Some applications executed by a CPU operate on data that is encrypted in a long term storage device or medium. The data may be encrypted to prevent piracy such as data from DVD or DVD-A (audio) formatted media. An application playing the content of the encrypted media must decrypt the data to prepare it for playback. This decrypted data is temporarily stored in system memory and transferred to a playback device such as an audio controller or video controller using the HC DMA engines of the appropriate I/O device.

### BRIEF DESCRIPTION OF THE DRAWINGS

Embodiments of the invention are illustrated by way of example and not by way of limitation in the figures of the accompanying drawings in which like references indicate similar elements. It should be noted that different references to “an” or “one” embodiment in this disclosure are not necessarily to the same embodiment, and such references mean at least one.

FIG. 1 is a block diagram of one embodiment of a computer system.

FIG. 2 is a block diagram of one embodiment of a player application environment.

FIG. 3 is a diagram of one embodiment of a data storage system.

FIG. 4 is a flowchart of one embodiment of a process for storing a location of a descriptor table address.

FIG. 5 is a flowchart of one embodiment of a process for handling a request for a descriptor table address.

FIG. 6 is a diagram of one embodiment of a circuit for protecting a descriptor table address.

### DETAILED DESCRIPTION

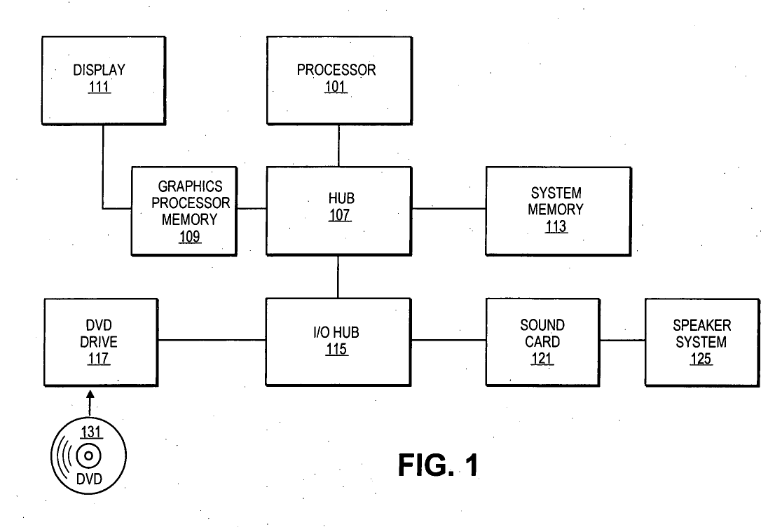

FIG. 1 is a block diagram of one embodiment of a computer system. In one embodiment, the computer system may include a processor 101 or set of processors for processing instructions and executing programs. In one embodiment, processor 101 may be in communication with a hub 107. Hub 107 may facilitate communication between processor 101, system memory 113, graphics processor 109 and similar devices. In one embodiment, hub 107 is a component or chipset on a mainboard or similar platform. Hub 107 may be a “Northbridge” chipset. In one embodiment, graphics processor 109 may be a component or chipset on a mainboard or similar platform. In another embodiment, graphics processor 109 may be on a peripheral card connected to the mainboard or platform via an accelerated graphics port (AGP) or similar connection. Graphics processor 109 may be in communication with a monitor 111 or display device. A display device may be a cathode ray tube (CRT) device, liquid crystal display device, plasma display device or similar display device.

In one embodiment, hub 107 may be in communication with input output (I/O) hub 115. I/O hub 115 may facilitate communication between hub 107 and I/O devices, such as storage devices including fixed storage devices, removable media devices, DVD drive 117 that reads DVD media 131 and similar devices. In one embodiment, I/O hub 115 may be a component or chipset on a mainboard or similar platform. I/O hub 115 may be a “Southbridge” chipset. I/O hub 115 may be in communication with a sound card 121. Sound card 121 may generate an audio signal to output to a speaker 125 or similar device. In one embodiment, an integrated audio controller may be used in place of or with a sound card.

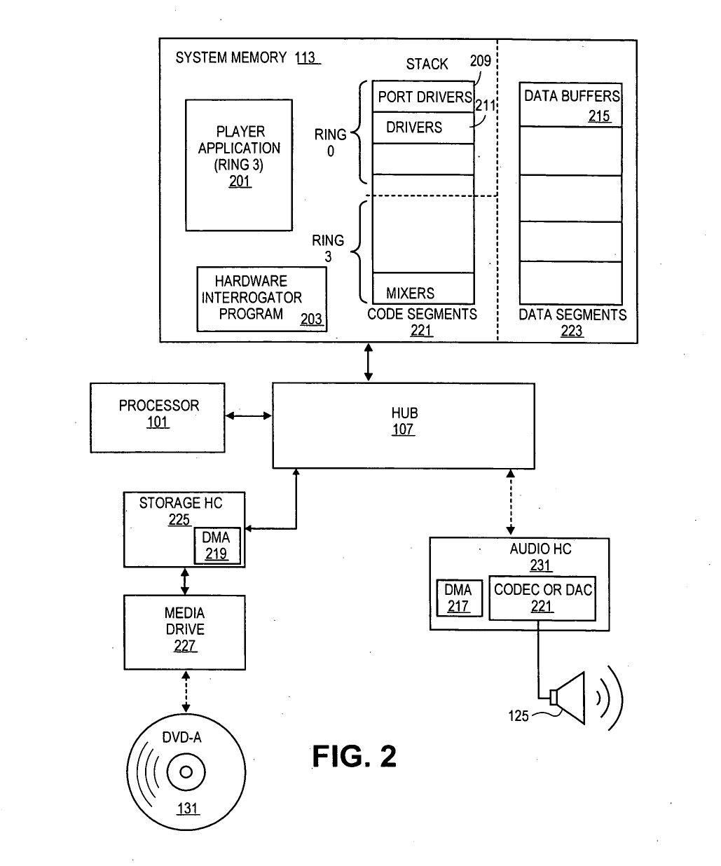

FIG. 2 is a diagram of one embodiment of a player application environment. A player application 201 may be an audio, video or similar playback application. In another embodiment, any application that accesses data that is designated to be protected may be supported. Player application 201 may be a processor ring 3 application. A ring is a part of a privilege system that designates the level of access that a program has to system resources. A ring 3 program has limited access to system resources and cannot access some resources directly or reconfigure these resources. A ring 0 program has a high level of access to system resources and may access and reconfigure most system resources. Most applications are designated as ring 3 applications to prevent them from inappropriately or accidentally altering system resources. Ring 0 programs are typically associated with the operating system, system resource management or similar tasks. Device drivers are examples of ring 0 programs. A malicious program that sought to access protected data may register as a ring 0 program by presenting itself as a device driver or similar code.

In one embodiment, the player application environment may include a software stack 209. A software stack may be a set of programs or utilities such as a mixer application 213, port driver 209, device driver 211 and similar programs. In one embodiment, some of the programs in the software stack may be ring 0 programs and other programs may be ring 3 programs. A player application environment may also include a set of data buffers 215. Data buffers 215 may not occupy a contiguous physical address space in system memory 113. Data buffers 215 may contain data utilized by player application 201 for generating video or audio output. Data buffers 215 may contain encrypted or decrypted audio or video data. Decrypted data may be stored in data buffers 215 prior to transfer to an audio or video output device. System memory may be logically divided between space for code segments 221 and data segments 223.

In one embodiment, player application 201 may retrieve data from a long term storage device via a storage host controller (HC) 225 and by the use of a storage software stack (not depicted). Direct memory access (DMA) engine 219 or similar memory controller in the storage HC 225 manages the transfer of blocks of data from storage device 227 and media 131 to system memory 113. In another embodiment, data may be retrieved from any source such as a storage device, network connection, user input, application or similar source and stored in system memory 113. DMA engine 217 or similar memory controller in audio HC 131 manages the transfer of data from system memory 113 to output devices. Player application 201 and processor 101 may utilize the data while stored in system memory 113. For example, DMA 219 may manage the retrieval of data to be decrypted by player application 201 from DVD-Audio (DVD-A) 131 to data buffers 215 for decrypting and processing by player application 201. DMA engine 217 may facilitate the transfer of decrypted DVD-A data from data buffers 215 to audio HC 231. Audio HC 231 may contain a “codec” 221 or digital to analog converter (DAC) to convert the digital data into a signal to output to a speaker system 125. Audio HC 231 may be part of a sound card or similar peripheral or integrated chipset.

In one embodiment, player application 201 may be executed by a processor 101. Processor 101 may also execute programs from the stack. A malicious program 203 may be present in the computer system and executed by processor 101. The malicious program 203 may be registered as a ring 0 program giving it access to system resources. Malicious program 203 may be a hardware interrogator (HI) program that queries a DMA controller (e.g., DMA controllers 217, 219) to obtain the location of data buffers 215. HI program 203 may then obtain the decrypted data that a player application seeks to protect. HI program 203 may be used to capture the decrypted audio or video data. This decrypted data may then be reproduced and pirated. HI program 203 may attempt to determine the location of decrypted or other data that is desired to be protected by querying any DMA controller that handled the data in the computer system.

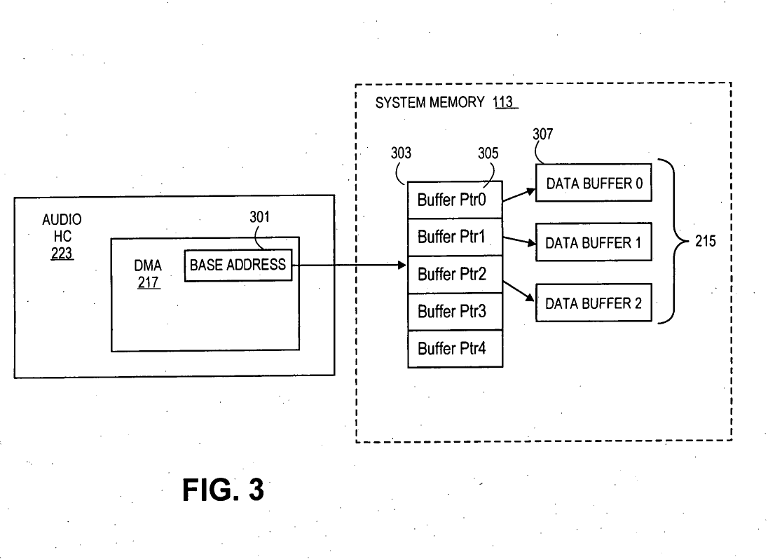

FIG. 3 is a diagram of one embodiment of a memory storage hierarchy. In one embodiment, data stored in system memory 113 may be scattered across a set of data buffers. DMA engine 217 may track the location of a descriptor list table 303. Descriptor list table 303 contains a set of pointers to each member of the set of data buffers storing data for an application. DMA controller 217, audio controller 223, or similar device may store the base address of descriptor table 303 in a base address storage register 301. Each entry in descriptor list table 303 may have a pointer 305 to the base address location of a data buffer 307. The entries of descriptor list table 303 may also contain additional data related to the data buffer that is at the pointer location. Table entry 305 may include a pointer, buffer length, commands and similar fields describing the related data buffer 307. Descriptor list table 303 may have any number of entries that track the location of any number of data buffers. In another embodiment, any data structure may be used to track the location of data buffers including linked lists, hash tables and similar data structures. Also the location of data buffers may be indicated in entries by any appropriate indicator including base address, address range, offset from a known address or similar indications. Although DMA engine 217 of audio HC 223 is used as an example, any DMA engine and HC or similar devices may be utilized and operate according to this description.

In one embodiment, if the location of data used by a player application is not obfuscated by DMA engine 217 or similar device, then an HI program may utilize DMA controller 217 to pirate decrypted data from data buffers 215. The function and location of DMA engines may be well known allowing an HI program to exploit this knowledge. For example, a base address register of a DMA controller may be a known location. The HI program may read base address register 301. The HI program may utilize the base address to read descriptor list table 303. The HI program may then obtain the decrypted data stored in the data buffers in system memory 113.

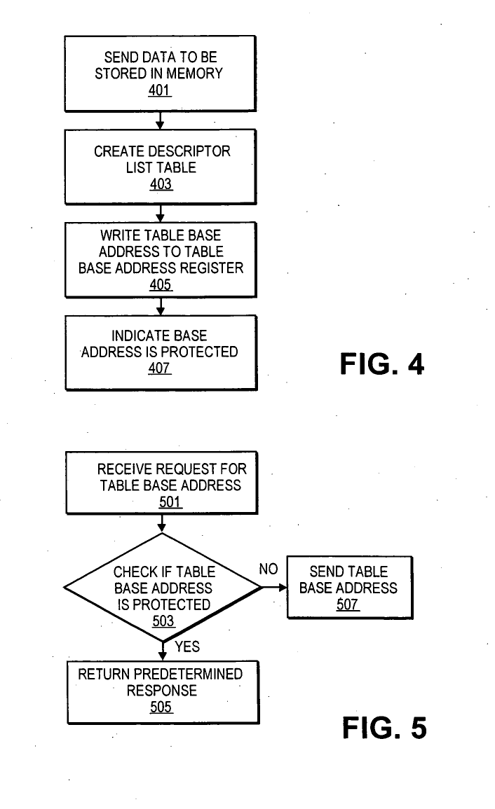

FIG. 4 is a flowchart of the process for storing protected data. Data to be decrypted may be retrieved and stored in data buffers prior to decryption by a processor, hub, HC, DMA controller or similar device. This data may then be accessed by a decryption program that may be part of a player application or similar application. In one embodiment, data that has been decrypted by a player application may be sent to be stored in a data buffer before being transferred to an output device (block 401). In another embodiment, the data may be decrypted in the data buffer where it is stored. In one embodiment, a memory hub, HC, DMA controller or similar device determines a set of data buffers in which to store the decrypted data. In another embodiment, any type of data that an application seeks to protect may be stored in system memory. As the data is stored into each data buffer a descriptor list table may be constructed and an entry corresponding to each data buffer is created in the descriptor list table (block 403). In another embodiment, this descriptor list table may be constructed during data retrieval.

In one embodiment, when a transfer has completed a base address for the descriptor list table is stored in a register in the hub, HC, DMA controller or similar device (block 405). If the data stored in the set of data buffers is to be protected from HI type programs a value may be set to indicate that the base address register and thereby the data buffers are to be protected. In one embodiment, an indicator may be a separate value, register, storage space or other indicator. In another embodiment, the indicator value may be encoded into the base address. For example, a base address may be aligned along 8 byte lines of system memory. A lower order bit in the base address register in this context is not needed to locate the descriptor list table due to the known 8 byte alignment. A lower order bit may be set to indicate that the address is to be protected. Any bit in the address, any encoding in the address or any external indicator may be used to indicate a protected status. In another embodiment, any location indicator for the description list table may be used in place of a base address.

FIG. 5 is a flowchart of a process for protecting a base address of a descriptor list table. In one embodiment, the hub, HC, DMA engine or similar device may receive a read request for the base address in the base address register (block 501). A check may then be made for the protection mode indicator to determine if the base address has a protected status (block 503). A check may be made by accessing a special storage unit, checking an encoding of the base address or by similar means. If the base address is stored in a protected mode then a predetermined response is given to the requesting program (block 505). In one embodiment, a false address or fixed value may be given to the requesting program. In another embodiment, a signal indicating that the register or device is unavailable or non-responsive is returned to the requesting device or program. If a base address is not in a protected mode then the device may return the base address (block 507). A base address may not be in a protected mode because the program using the device does not utilize or support the protected mode, the device or program using the device is in a testing mode or similar circumstances may occur. The unprotected mode may be a default mode to provide backward compatibility with older architectures or programs. In another embodiment, any location indicator for the description list table may be used in place of the base address.

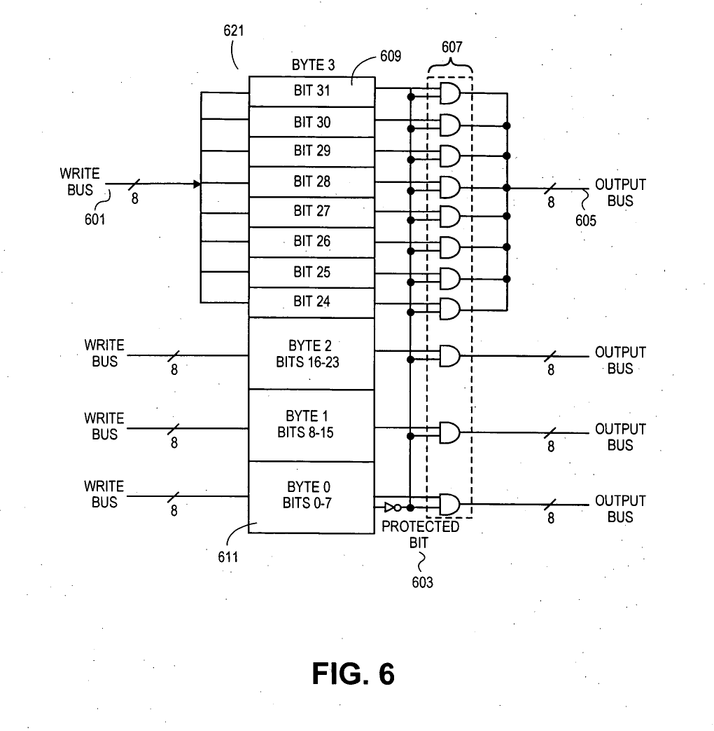

FIG. 6 is a diagram of one embodiment of a base address register providing a protected mode. In one embodiment, a base address register 621 may be written to by a write bus 601. In one embodiment, base address register 621 may store a 32 bit address. In another embodiment, base address register 621 may have any number of bits of any size. Write bus 601 may be any size. The size of write bus 601 may correspond to the size of the register.

In one embodiment, base address register 621 may be composed of a set of byte registers 611. Byte registers may each be composed of a set of bits 609 or latches. In one embodiment, a single bit in one of the bytes of base address register 621 may be the protected mode indicator. Base address register 621 may also have output lines to allow the contents of register 621 to be read by another device or program. The contents of base address register 621 may be output through output bus 605.

In one embodiment, a protected mode may be enforced by a protection circuit 607 or similar control circuit. In one embodiment, circuit 607 is a set of AND gates. Each AND gate may receive the output line from a bit of base address register 621 and the protected bit or indicator. If the protected bit indicates base address register 621 is in the protected mode then the AND gates output only logical zeros, thereby obfuscating the location of protected data. In another embodiment, any logical structure equivalent to protection circuit 607 may be utilized in its place to obfuscate a protected address or location.

In another embodiment, any signal other than the address may be generated when register 621 is in a protected mode to obfuscate the location of protected data. In one embodiment, an address that indicates that a device is not functional or present may be generated and returned to a requesting device or program. If base address register 621 is not in a protected mode then the address stored in the register may be output to the output bus 605. In one embodiment, the protected mode may be encoded as a single bit in base address register 621. The default non-protected encoding may be a bit that is a logical zero. In this embodiment, the bit may be inverted by an inverter 603 to enable or disable the protection circuitry 607. In another embodiment, the protected status may be encoded in a set of bits, a separate storage device or similar indicator method. The protection circuitry may complement the alternative encoding ensuring that the base address is output only when the register is in a non-protected mode.

In one embodiment, the obfuscation system may support a process for storing and retrieving an address in a base address register when the register is in a non-protected mode. When the base address register is in a protected mode then it may prevent any application or device from reading the base address register. The only way to modify the register may be to write over a previous address. In one embodiment, a non-protected mode address may be changed into a protected address. A protected address may not be modified into a non-protected address.

The obfuscation system may be implemented in software, for example, in a simulator, emulator or similar software. A software implementation may include a microcode implementation. A software implementation may be stored on a machine readable medium. A “machine readable” medium may include any medium that can store or transfer information. Examples of a machine readable medium include a ROM, a floppy diskette, a CD-ROM, an optical disk, a hard disk, a radio frequency (RF) link, and similar media and mediums.

In the foregoing specification, the invention has been described with reference to specific embodiments thereof. It will, however, be evident that various modifications and changes can be made thereto without departing from the broader spirit and scope of the embodiments of the invention as set forth in the appended claims. The specification and drawings are, accordingly, to be regarded in an illustrative rather than a restrictive sense.

1. A method comprising:
storing data in a memory device;
writing a pointer related to a location of the data to a known location;
indicating the data has a protected status; and
preventing a read of the pointer from the known location.

2. The method of claim 1, further comprising:
returning a fixed value in response to a read request for the pointer.

3. The method of claim 1, wherein the known location is a register in a memory controller.

4. The method of claim 1, further comprising:
storing the location of the data in a descriptor list table,
wherein the pointer indicates the location of the descriptor list table.

5. A device comprising:
a first memory device to store a pointer to a descriptor list table;
a second memory device to store an indicator of a protected status; and
a control circuit to prevent a read of the pointer.

6. The device of claim 5, further comprising:
an output circuit to generate a fixed output when the pointer has a protected status.

7. The device of claim 5, wherein the first memory device is a register in a memory controller.

8. A system comprising:
a memory device;
a processor;
a memory controller coupled to the memory device and processor, the memory controller to store a pointer to a descriptor list table and to prevent a read of the pointer when the pointer is in a protected mode; and
an integrated audio controller coupled to the memory controller to process audio data.

9. The system of claim 8, further comprising:
a removable media drive coupled to the memory controller to read encrypted data.

10. The system of claim 9, further comprising:
a graphics device to display encrypted data from the removable media drive.

11. A device comprising:
means for receiving a request for a location of data;
means for determining a protected status of the data; and
means for returning a predetermined signal if the data has a protected status.

12. The device of claim 11, further comprising:
means for storing an indicator of the protected status.

13. The device of claim 11, further comprising:
means for returning a location of the data if the data has an unprotected status.

14. A machine readable medium having instructions stored therein which when executed cause a machine to perform a set of operations comprising:
receiving a request for descriptor table base address;
determining if the descriptor table base address register is set in a protected mode; and
returning a fixed value if the register is in the protected mode.

15. The machine readable medium of claim 14, having further instructions stored therein which when executed cause a machine to perform a set of operations further comprising:
storing an indicator of the protected mode.

16. The machine readable medium of claim 14, having further instructions stored therein which when executed cause a machine to perform a set of operations further comprising:
returning the descriptor table base address if the data is not in the protected mode.
